(19) United States
(12) Patent Application Publication
(10) Pub. No.: US 2019/0325431 A1
(43) Pub. Date: Oct. 24, 2019

(54) System and Method of Securely Exchanging Digital Token Currency for Goods and Services

(71) Applicant: SYB International Inc., Toronto (CA)

(72) Inventor: Howard Mann, Toronto (CA)

(21) Appl. No.: 16/272,810

(22) Filed: Feb. 11, 2019

Related U.S. Application Data
(60) Provisional application No. 62/661,456, filed on Apr. 23, 2018.
(60) Provisional application No. 62/682,068, filed on Jun. 7, 2018.

(51) Int. Cl. G06Q 20/36; G06Q 20/40; H04L 9/06

(52) U.S. Cl. CPC G06Q 20/3672; H04L 9/0637; G06Q 20/405

(57) ABSTRACT

A system and method of securely exchanging digital token currency for goods and services is provided. The method allows a user with a consumer account to purchase goods and/or services with digital currency through the present invention. Moreover, the method allows a user with a retailer account to sell goods and/or services with digital currency through the present invention. The system includes a network of computing nodes which manages a blockchain ledger. The blockchain ledger is used to record and verify financial transactions between consumers and retailers in order for users to securely exchange digital currency for goods and services. Additionally, the method can authenticate new consumer accounts and financial transactions through the contact information of consumers.

The current application claims a priority to the U.S. Provisional Patent application Ser. No. 62/661,456 filed on Apr. 23, 2018 and a priority to the U.S. Provisional Patent application Ser. No. 62/682,068 filed on Jun. 7, 2018.

### FIELD OF THE INVENTION

The present invention relates generally to the field of data processing. More specifically, the present invention facilitates users with an online payment processing wallet using tokens.

### BACKGROUND OF THE INVENTION

Generally, a lot of people prefer online transactions rather than using cash, as online transactions have made the process of transferring funds from one account to another very easy. Moreover, the time taken to transfer funds nowadays is almost negligible. Further, people now do not have to worry about carrying cash all the time to purchase goods and services.

Usually, users may use available technologies and may initiate online transactions by scanning a QR code. However, capturing QR codes by cameras present on devices may be a difficult task for users.

However, some online transactions may be of high-risk for the customers and/or the retailers. Further, a type of product and/or service determines whether a corresponding online transaction is classified as high risk. Moreover, banks facilitating such high-risk transactions levy a significantly large amount from merchants and/or customers in the form of transaction fee.

On the other hand, cryptocurrencies using blockchain technology are being used for online transactions as they are safe, decentralized, with high transaction speed and very low transaction cost. However, the unstable value of cryptocurrencies is making it difficult to use cryptocurrencies for daily transactions.

Therefore, there is a need for improved methods and systems to facilitate users with an online payment processing wallet using tokens that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an online platform to facilitate users with an online payment processing wallet using tokens is disclosed. Firstly, the online platform may receive, using a communication device, a request from a user device associated with a user to register on the online platform. Further, the online platform may transmit, using the communication device, a login code to the user device via text (e.g. SMS). Further, the online platform may generate, using a processing device, a user account based on the login code entered on the user device. Further, the online platform may assign, using the processing device, a wallet to the user account. Further, the online platform may receive, using the communication device, indication of a payment method from the user device. Further, the online platform may log in, using a storage device, a blockchain ledger. Further, the online platform may receive, using the communication device, a request to receive funds from another user device such as a retailer device. Further, the online platform may update, using the storage device, the blockchain ledger based on the request to receive funds from the another user device. Further, the online platform may generate, using the processing device, a payment request based on the request to receive funds from the another user device. Further, the online platform may transmit, using the communication device, the payment request to the user device. Further, if the user accepts the payment request, then the online platform may move, using the processing device, the tokens from the wallet to a business wallet associated with the retailer. Further, the online platform may update, using the storage device, the blockchain ledger. Moreover, the online platform may transmit, using the communication device, a notification of successful transaction to the another user device. Further, if the user declines the payment request, then the online platform may update, using the storage device, the blockchain ledger. Moreover, the online platform may transmit, using the communication device, a notification of unsuccessful transaction to the another user device.

According to some embodiments, a system to facilitate users with an online payment processing wallet using tokens on an online platform is disclosed. Further, the system may include a communication device, a processing device, and a storage device. Further, the communication device may be used to receive a request from a user to register on the online platform. Further, the communication device may be used to transmit a login code from the online platform to the user device via text (e.g. SMS). Further, the communication device may be used to receive an indication of a payment method from the user. Further, the communication device may be used to receive a request to receive funds by another user such as a retailer. Further, the communication device may be used to transmit the payment request to the user. Further, the communication device may be used to transmit a notification of successful transaction to the another user. Further, the communication device may be used to transmit a notification of unsuccessful transaction to the another user. Further, the processing device may be used to generate a user account based on the login code entered by the user. Further, the processing device may be used to assign a wallet to the user account. Further, the processing device may be used to move the tokens from the wallet to a business wallet using the processing device. Further, the storage device may be used to login to a blockchain ledger. Further, the storage device may be used to update the blockchain ledger based on the request to receive funds from the another user. Further, the storage device may be used to update the blockchain ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 displays a diagram of the system of the present invention.

FIG. 2A is flow chat illustrating the overall method of the present invention.

FIG. 2B is a flow chart illustrating a continuation of the overall method of the present invention.

FIG. 3 is a flow chart illustrating the sub-process of a virtual wallet for consumers provided by the present invention.

FIG. 4 is a flow chart illustrating the sub-process of converting currency into virtual tokens.

FIG. 5 is a flow chart illustrating the sub-process of a virtual wallet for retailers provided by the present invention.

FIG. 6 is a flow chart illustrating the sub-process for authentication and communication between a consumer and retailer.

FIG. 7 is a flow chart illustrating the sub-process for verification of a financial between a consumer and a retailer.

FIG. 8 is a flow chart illustrating the sub-process for creation and authentication of new consumer accounts.

FIG. 9 is a flow chart illustrating the sub-process for a consumer to view the blockchain ledger.

FIG. 10 is a flow chart illustrating the sub-process for a retailer to view the blockchain ledger.

FIG. 11 is a flow chart illustrating the sub-process for a smart contract between a consumer and a retailer.

FIG. 12 is a flow chart illustrating the sub-process for how a financial transaction is process using the smart contract.

FIG. 13A is a diagram illustrating an exemplary embodiment of the present invention.

FIG. 13B is diagram illustrating a continuation of the exemplary embodiment of the present invention.

FIG. 13C is diagram illustrating a continuation of the exemplary embodiment of the present invention.

### DETAIL DESCRIPTIONS OF THE INVENTION

All illustrations of the drawings are for the purpose of describing selected versions of the present invention and are not intended to limit the scope of the present invention.

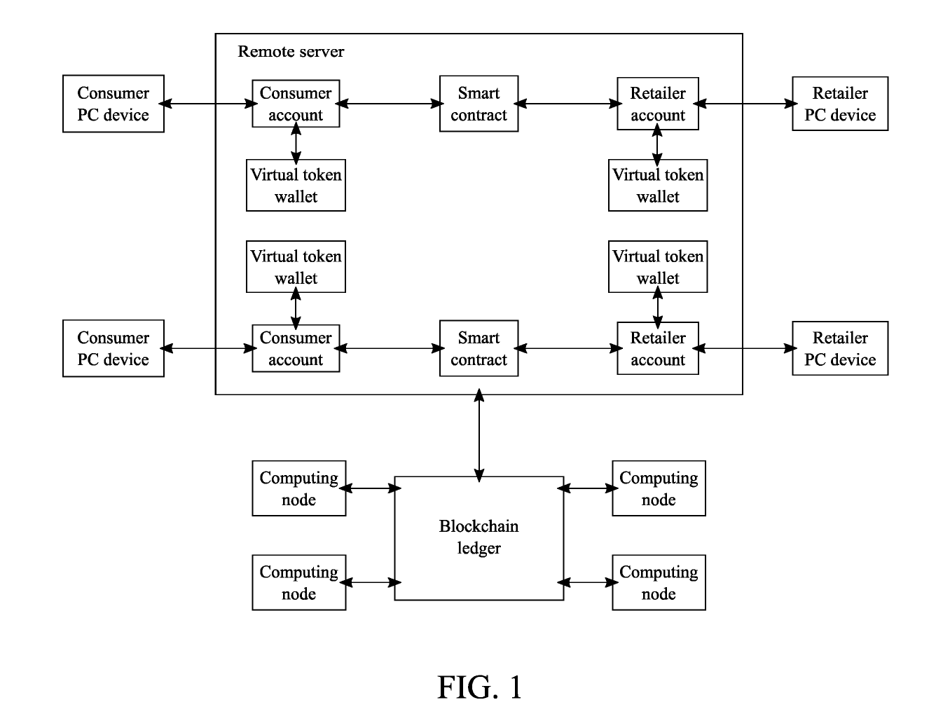

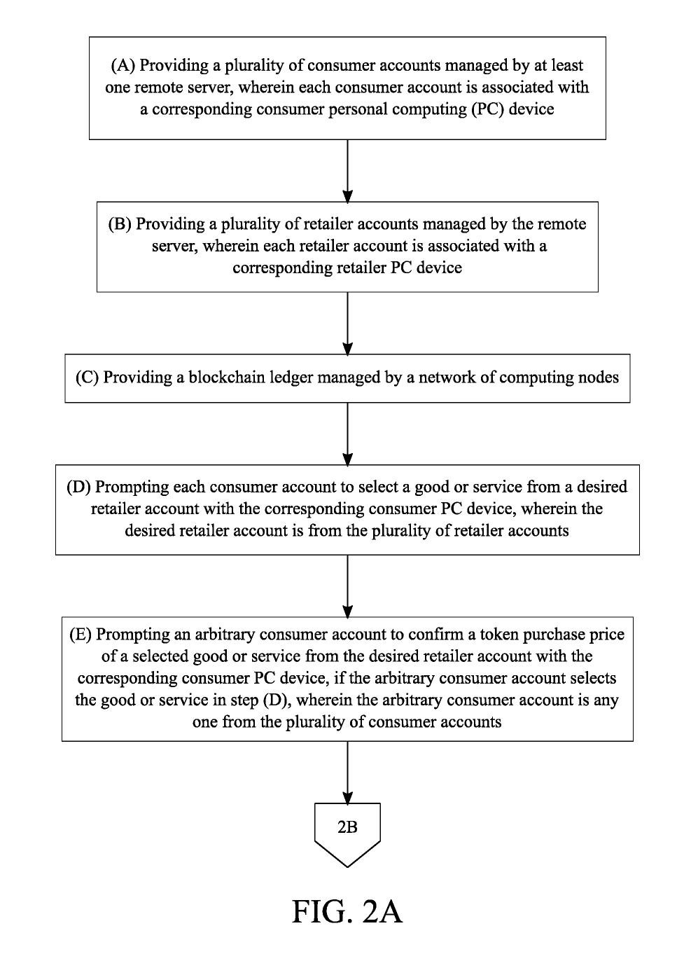

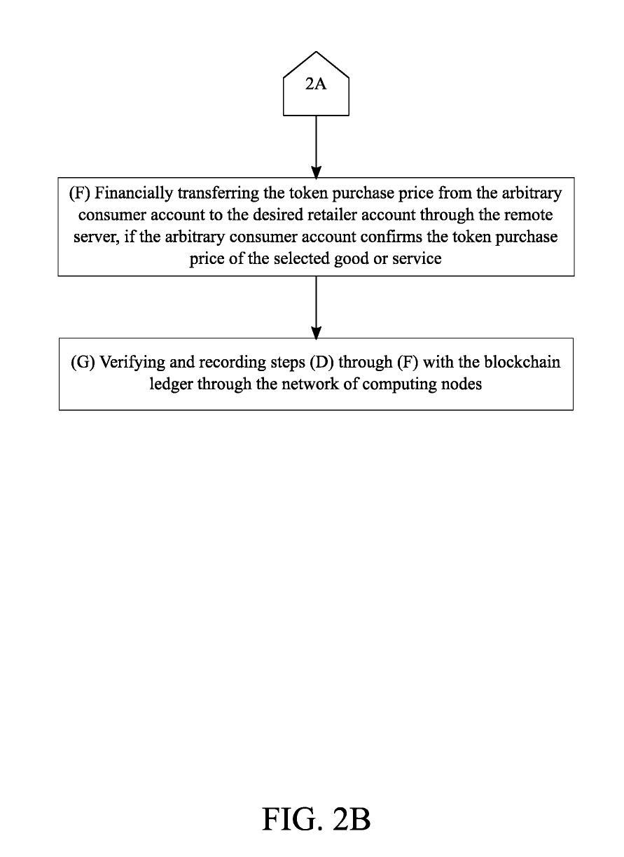

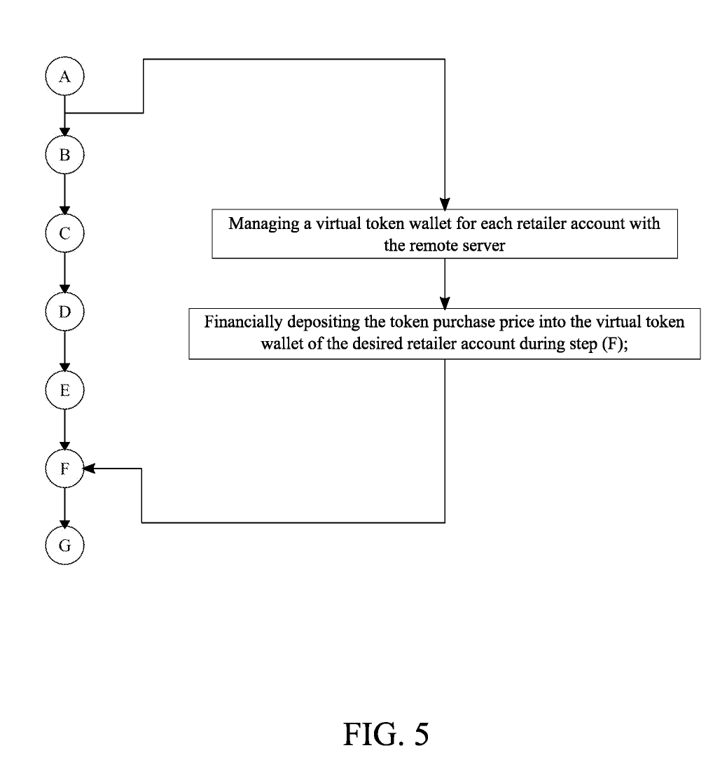

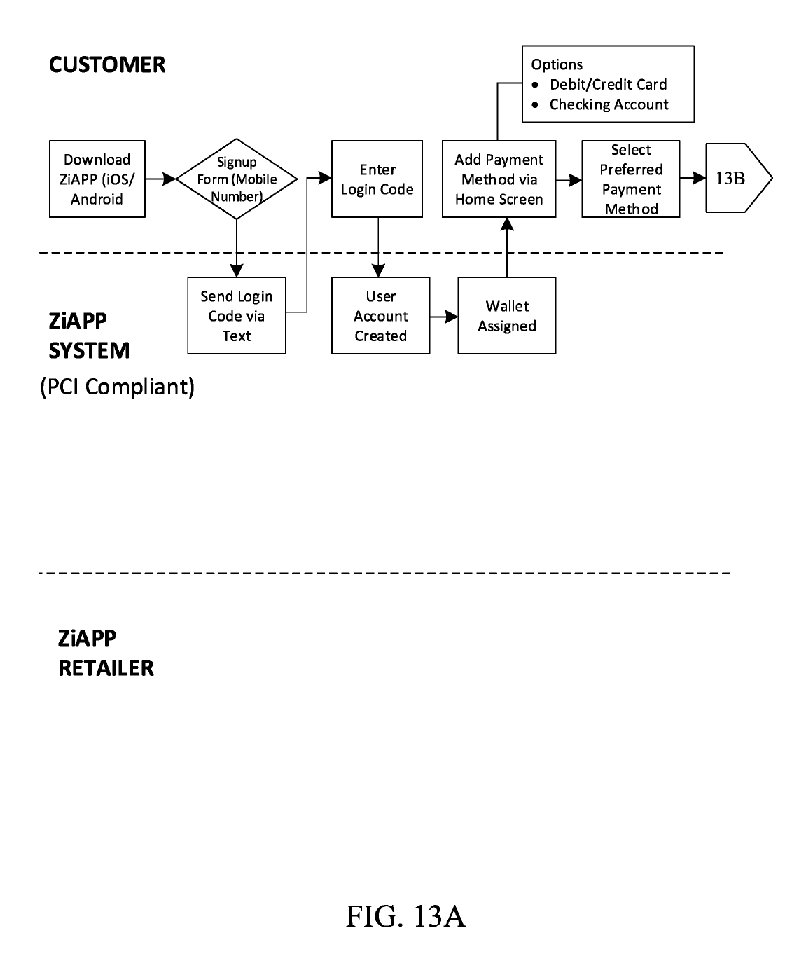

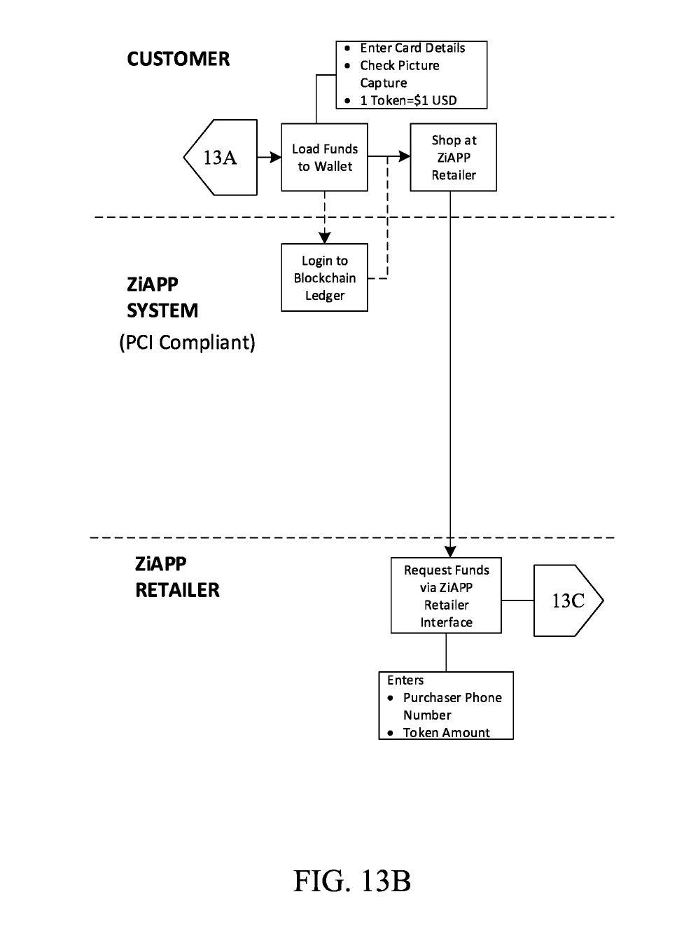

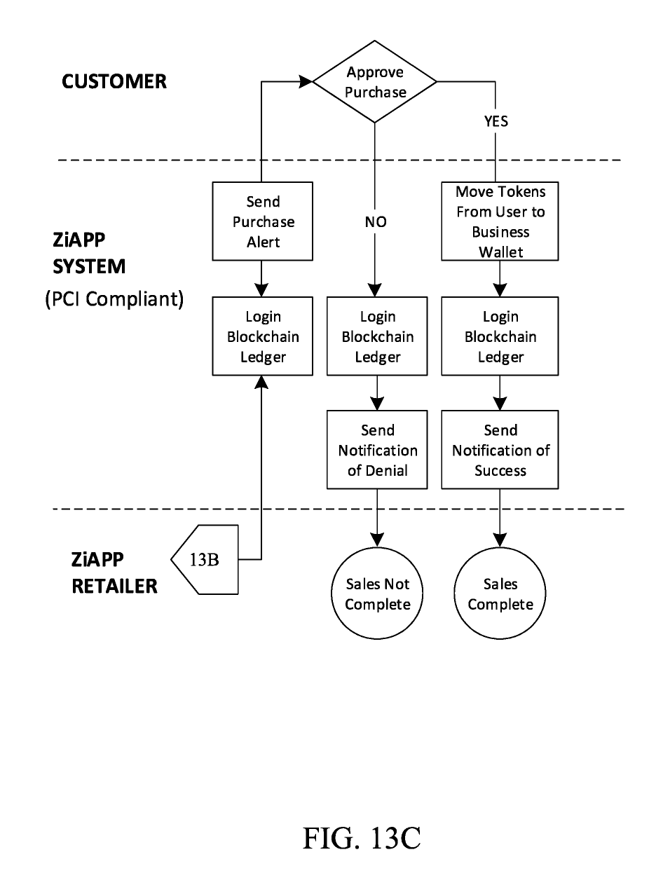

In reference to FIGS. 1 through 13, the present invention is a method of securely exchanging digital token currency for goods and services. In further detail, the present invention is an online platform that connects consumers with retailers in order for the consumer to purchase goods and/or services with digital token currency. With reference to FIG. 1, the system of the present invention is provided with at least one remote server and a network of computing nodes. The remote server is used to manage a plurality of consumer accounts and a plurality of retailer accounts. The plurality of consumer accounts and the plurality of retailer accounts allow the present invention to identify each user that is user and interacting with the present invention. The remote is used as a hub to exchange information between the plurality of consumer accounts and the plurality of retailer accounts, to store data provided by the plurality of consumer accounts and the plurality of retailer accounts, and to manage the administrative process of the present invention. With reference to FIG. 2A and furthermore, each consumer account is associated with a corresponding consumer personal computing (PC) device (Step A). A consumer account allows a user to purchase goods and/or services with digital currency through the present invention. The consumer PC device allows each user with a consumer account to interact with and use the present invention. The consumer PC device may be any type of computing device such as, but not limited to, a desktop computing device or a mobile computing device. Similarly, each retailer account is associated with a corresponding retailer PC device (Step B). A retailer account allows a user to sell goods and/or services with digital currency through the present invention. The retailer PC device allows a retailer with a retailer account to interact with and use the present invention. The retailer PC device may be any type of computing device such as, but not limited to, a desktop computing device or a mobile computing device. A network of computing nodes is used to manage a blockchain ledger (Step C). The network of computing nodes is a plurality of electronic storage devices communicably connected to each other in order to store information that cannot be easily modified. The blockchain ledger is used to record interactive information between the plurality of consumer accounts and the plurality of retailer accounts. The recorded information on the blockchain ledger is resistant to any modification. This protects the interactive information between the plurality of consumer accounts and the plurality of retailer accounts. The interactive information is specifically information such as, but not limited to, transaction information, transaction amounts, and/or transaction dates.

With reference to FIG. 2A, the method of the present invention follows an overall process that allows a consumer to purchase goods and/or services from a retailer using digital token currency. The corresponding consumer PC device prompts each consumer account to select a good or service from a desired retailer account (Step D). The desired retailer account is any retailer account from the plurality of retailer accounts. The desired retailer account is a retailer account that a consumer account wants do business with. The plurality of retailer accounts may be displayed to each consumer account in a list format with the corresponding consumer PC device. Consequently, the corresponding consumer PC device prompts an arbitrary consumer account to confirm a token purchase price of a selected good or service from the desired retailer account, if the arbitrary consumer account selects the good or service in Step D (Step E). The arbitrary consumer account is any consumer account from the plurality of consumer accounts. The corresponding consumer PC device may display a confirmation screen, that allows a user to confirm or deny the token purchase price, to the arbitrary consumer account. The token purchase price is a specific amount of digital currency which is decided by the desired retailer account for the selected good or service. Additionally, a token from the token purchase price can be a fixed-exchange token or be equal to any currency such as, but not limited to, a USD or a Euro. With reference to FIG. 2B, the remote server financially transfers the token purchase price from the arbitrary consumer account to the desired retailer account, if the arbitrary consumer account confirms the token purchase price of the selected good or service (Step F). If the arbitrary consumer account denies the token purchase price, the arbitrary consumer account is free to select another good or service from any retailer account. The blockchain ledger verifies and records Steps D through F through the network of computing nodes (Step G). This protects the financial transaction between the arbitrary consumer account and the desired retailer account. Additionally, this prevents any modification to the financial transaction between the arbitrary consumer account and the desired retailer account.

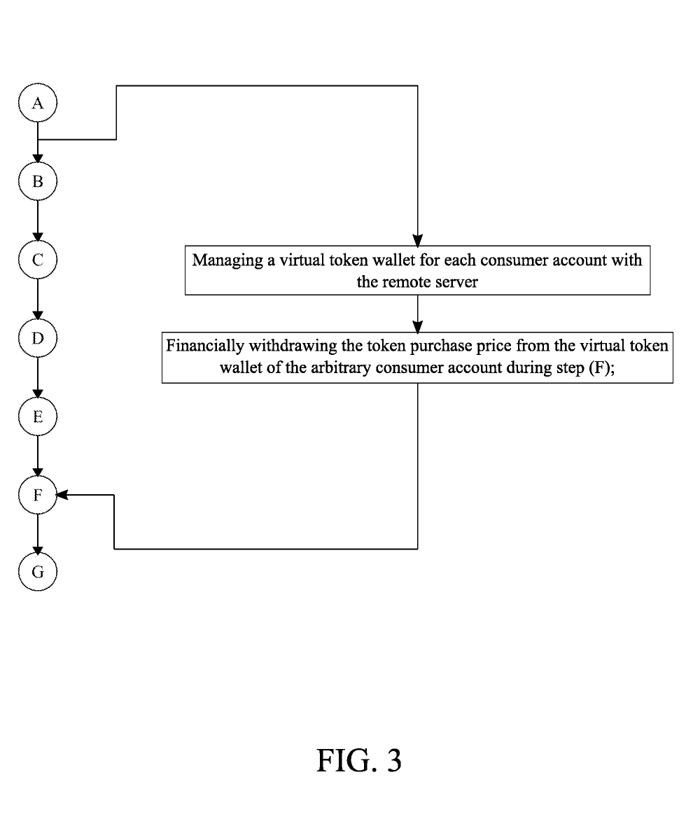

In order for a consumer to provide funds for goods and/or services from retailers and with reference to FIG. 3, the remote server manages a virtual token wallet for each consumer account. The virtual token wallet is a service offered through the present invention which allows each consumer account to make electronic transactions. In more detail, the virtual token wallet allows each consumer account to store tokens which may be compiled into the token purchase price. The token purchase price is finally withdrawn from the virtual token wallet of the arbitrary consumer account during Step F. This compiles tokens from the virtual token wallet of the arbitrary consumer account into the token purchase price in accordance to the selected good or service and transfers the token purchase price to the desired retailer account.

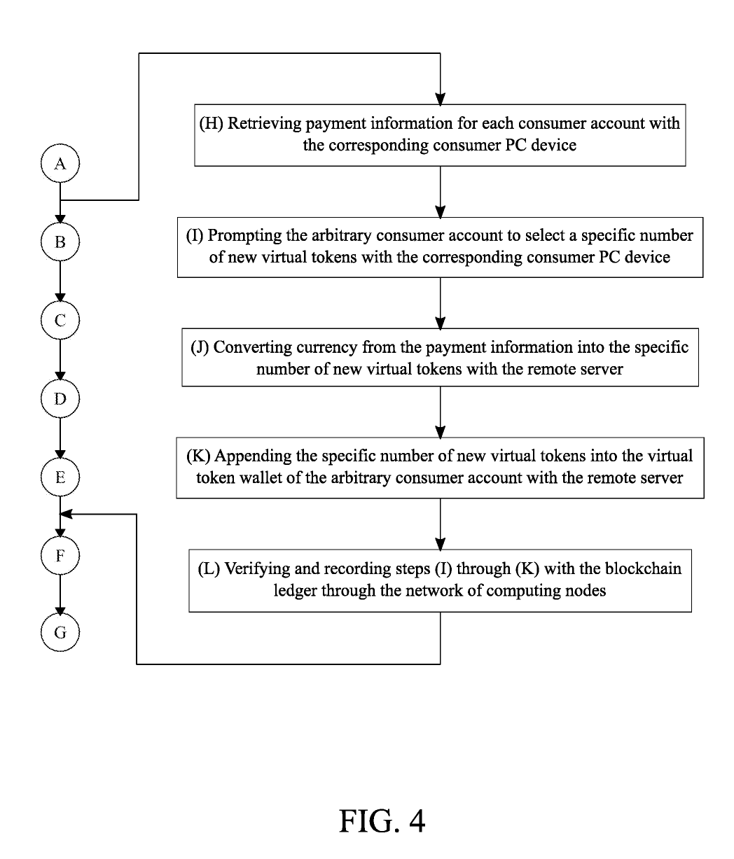

In order for a consumer to acquire funds to purchase goods and/or services from retailers and with reference to FIG. 4, the corresponding consumer PC device retrieves payment information for each consumer account (Step H). The payment information can be any type of payment information such as, but not limited to, credit card information, bank account information, or debit card information. The corresponding consumer PC device prompts the arbitrary consumer account to select a specific number of new virtual tokens (Step I). The arbitrary consumer can manually input the specific number of new virtual tokens or select the specific number of new virtual tokens from a list. The remote server converts currency from the payment information into the specific number of new virtual tokens with the remote server (Step J). As mentioned previously, a token from the specific number of new virtual tokens can be a fixed-exchange token or be equal to any currency such as, but not limited to, a USD or a Euro. In further detail, the specific number of new virtual tokens is converted based on conversion rates decided by the administrators of the present invention. The remote server appends the specific number of new virtual tokens into the virtual token wallet of the arbitrary consumer account (Step K). In further detail, this step transfers and stores the specific number of new virtual tokens for each consumer account in order for each consumer to make electronic transactions with the specific number of new virtual tokens. The blockchain ledger verifies and records Steps I through K through the network of computing nodes (Step L). This protects the electronic conversion of the payment information into the specific number new virtual tokens. Additionally, this prevents any modification to the electronic conversion.

In order for a retailer to receive funds after providing a good and/or service and with reference to FIG .5, the remote server manages a virtual token wallet for each retailer account. Similar to the virtual token wallet for consumer accounts, the virtual token wallet is a service offered through the present invention which allows each retailer account to make electronic transactions. In further detail, the virtual token wallet allows the desired retailer account to receive the token purchase price. The token purchase price is financially deposited into the virtual token wallet of the desired retailer account during Step F. This allows the desired retailer account to be compensated for the provided good or service.

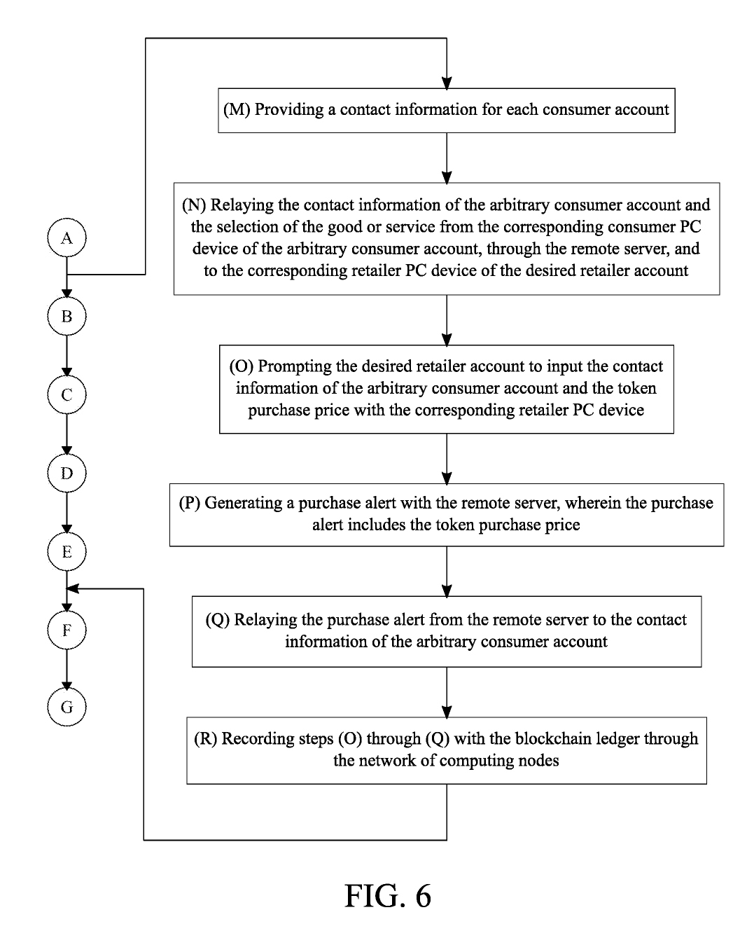

In order for the present invention to include account verification and with reference to FIG. 6, a contact information is provided for each consumer account (Step M). The contact information may be any type of contact information but preferably is a phone number of a consumer. The remote server relays the contact information of the arbitrary consumer account and the selection of the good or service from the corresponding consumer PC device of the arbitrary consumer to the corresponding retailer PC device of the desired retailer account (Step N). This verifies that the arbitrary consumer account is from the plurality of consumer accounts in order for the present invention to process a secure financial transaction. The corresponding retailer PC device prompts the desired retailer account to input the contact information of the arbitrary consumer account and the token purchase price (Step O). This allows the desired retailer account to confirm the arbitrary consumer account from the plurality of consumer accounts. The remote server generates a purchase alert (Step P). The purchase alert can be a notification which verifies the selected good or service and allows the arbitrary consumer account to confirm or deny the transaction. Additionally, the purchase alert includes the token purchase price. The purchase alert is relayed from the remote server to the contact information of the arbitrary consumer account (Step Q). This step authenticates that the arbitrary consumer account is the correct consumer account from the plurality of consumer accounts. The blockchain ledger records Steps O through Q through the network of computing nodes (Step R). This step prevents any modification to the purchase alert and protects the transaction communication between the arbitrary consumer account and the desired retailer account.

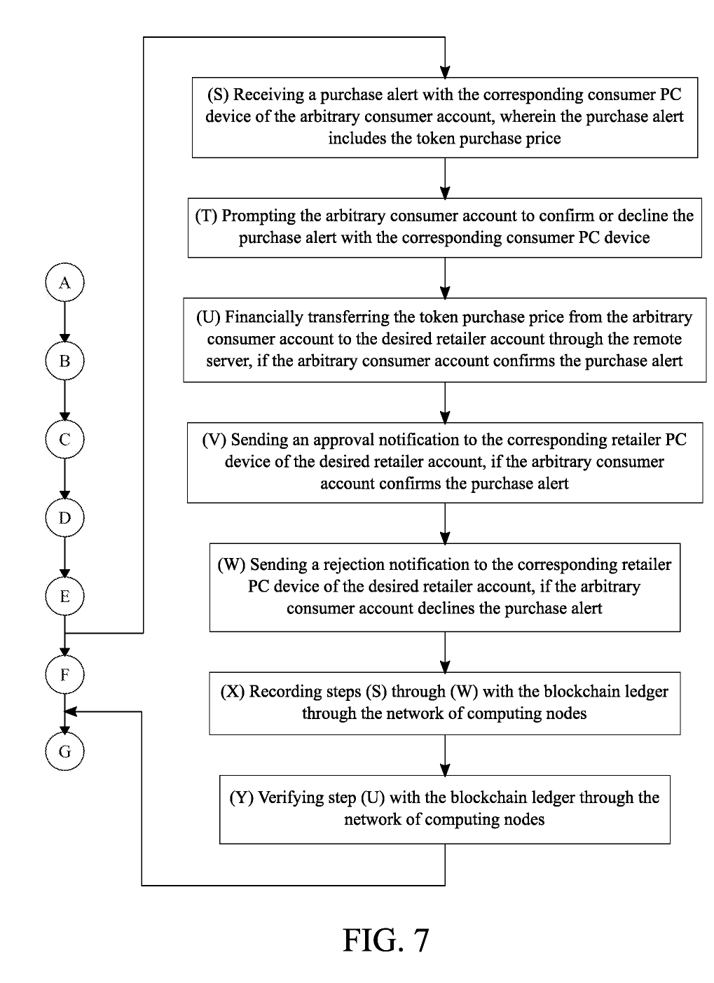

In order for a consumer account to confirm or decline a purchase and with reference to FIG. 7, the corresponding consumer PC device of the arbitrary consumer account receives the purchase alert (Step S). The purchase alert is preferably a notification sent directly to the default messaging service of the corresponding consumer PC device of the arbitrary consumer account. The corresponding consumer PC device prompts the arbitrary consumer account to confirm or decline the purchase alert (Step T). The arbitrary consumer account can review the purchase alert to verify the selected good or service and the token purchase price. If the selected good or service is correct and the consumer finds the token purchase price viable, the arbitrary consumer account can confirm the purchase alert. If the selected good or service is incorrect, or the consumer finds the token purchase price nonpractical, the arbitrary consumer account can decline the purchase alert. If the arbitrary consumer account confirms the purchase alert, the remote server financially transfers the token purchase price from the arbitrary consumer account to the desired retailer account (Step U). The token purchase price is withdrawn from the virtual token wallet of the arbitrary consumer account. If the arbitrary consumer account confirms the purchase alert, an approval notification is sent to the corresponding retailer PC device of the desired retailer account (Step V). The approval notification confirms the purchase by the arbitrary consumer account therefore allowing the desired retailer to securely provide the selected good or service. If the arbitrary consumer account declines the purchase alert, a rejection notification is sent to the corresponding retailer PC device of the desired retailer account (Step W). The rejection notification declines the purchase by the arbitrary consumer account therefore notifying the desired retailer to not provide the selected good or service. The blockchain ledger records Steps S through W through the network of computing nodes (Step X). This allows the financial transaction to be reviewed without the risk of any modifications. The blockchain ledger verifies Step U through the network of computing nodes (Step Y). This authenticates the financial transaction between the arbitrary consumer account and the desired retailer account.

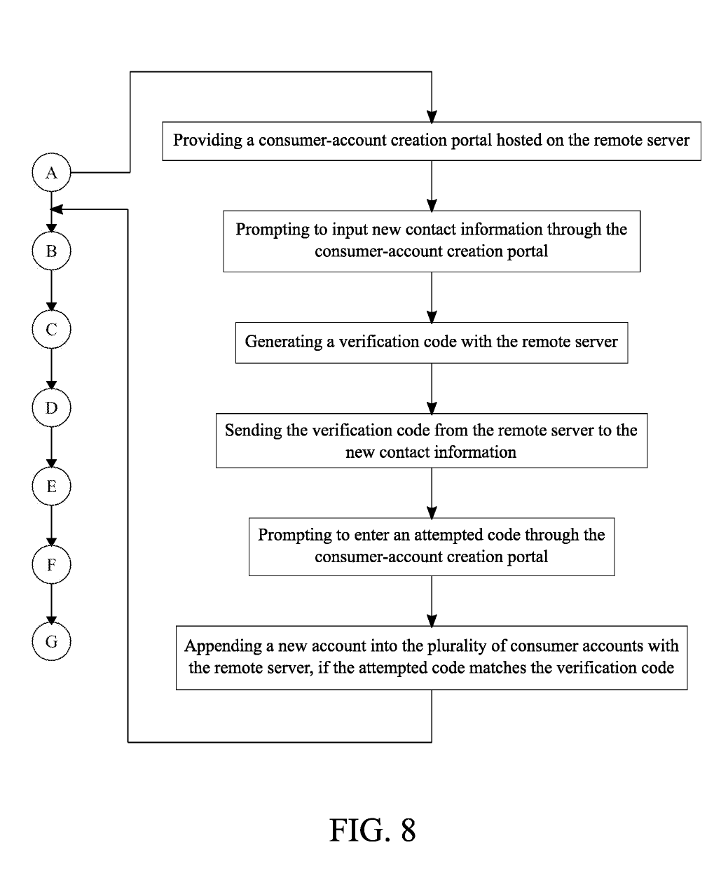

In order for a user to create and authenticate a consumer account and with reference to FIG. 8, a consumer-account creation portal is hosted on the remote server. The consumer-account creation portal allows a user to create a new consumer account. The consumer-account creation portal prompts to input new contact information. The contact information can include information such as, but not limited to, the name of the consumer, the email of the consumer, the address of the consumer, and the phone number of the consumer. The remote server generates a verification code. The verification code is preferably an alphanumeric code. The remote server then sends the verification code to the new contact information. The verification code is preferably sent to the phone number of the consumer. The consumer-account creation portal prompts to enter an attempted code. The attempted code is an attempt by a user to verify the creation of a consumer account. The user is preferably provided one to three attempts to enter an attempted code. If the attempted code matches the verification code, the remote server appends a new account into the plurality of consumer accounts. This allows the new account to acquire digital currency, purchase goods or services through the present invention, and use other services offered through the present invention. If the attempted code does not match the verification code, the user is denied a new account.

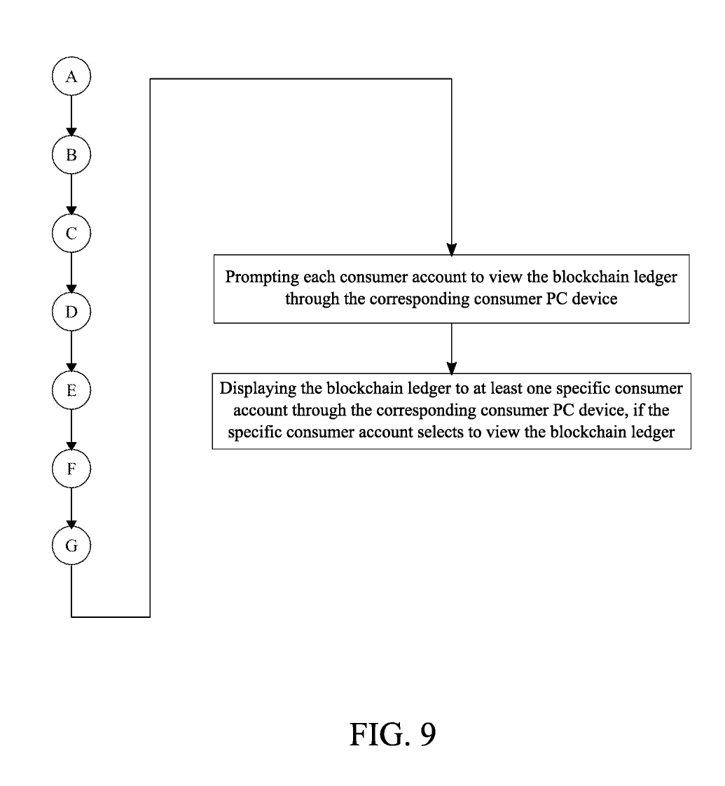

In order for a consumer account to review transaction history completed through the present invention and with reference to FIG. 9, the corresponding consumer PC device prompts each consumer account to view the blockchain ledger. As mentioned previously, the blockchain ledger contains transaction information for each consumer account. The corresponding consumer PC device displays the blockchain ledger to at least one specific consumer account, if the specific consumer account selects to view the blockchain ledger. The blockchain ledger can be displayed to the specific consumer account in a list format in order to easily reference different transaction records.

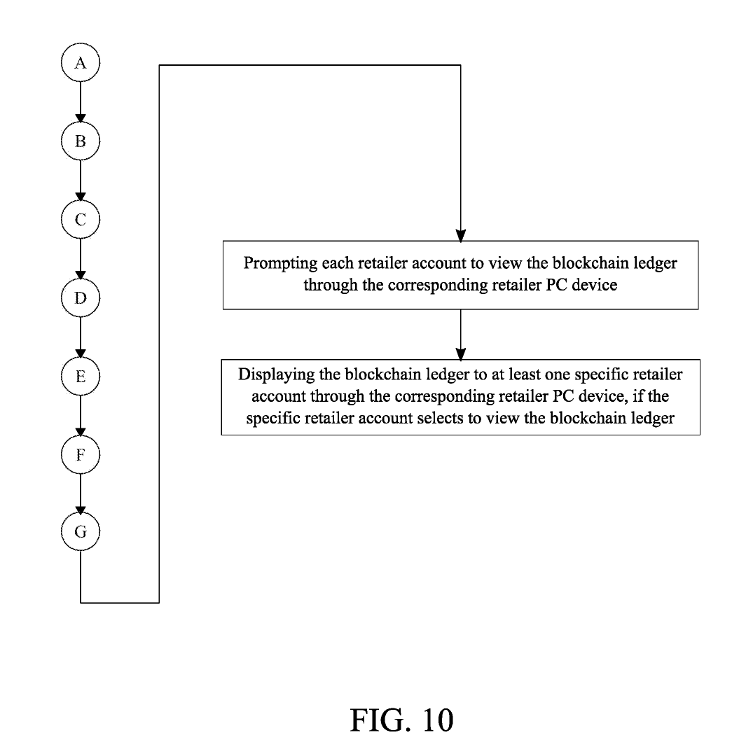

Similarly and in order for a retailer account to review transaction history completely through the present invention and with reference to FIG. 10, the corresponding retailer PC device prompts each retailer account to view the blockchain ledger. As mentioned previously, the blockchain ledger container transaction information for each retailer account. The corresponding retailer PC device displays the blockchain ledger to at least one specific retailer account, if the specific retailer account selects to view the blockchain ledger. The blockchain ledger can be displayed to the specific retailer account in a list format in order to easily reference different transaction records.

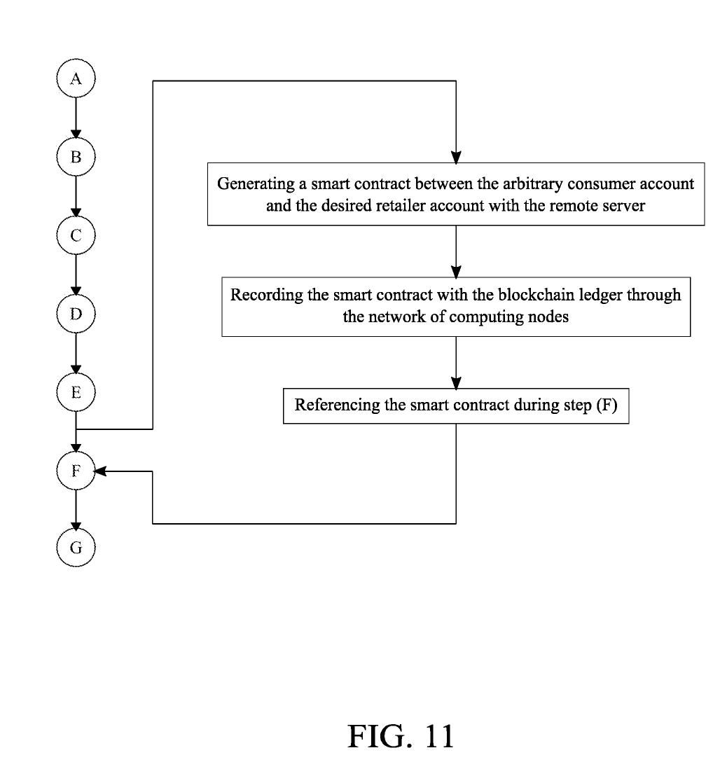

In order to create an agreement between consumer accounts and retailer accounts in the form of code and with reference to FIG. 11, the remote server generates a smart contract between the arbitrary consumer account and the desired retailer account. The blockchain ledger records the smart contract through the network of computing nodes. This deploys the smart contract to a blockchain environment. In further detail, the smart contract cannot be modified after the smart contract is recorded by the blockchain ledger which ensure integrity of any transactions while using the smart contract. The smart contract is referenced during Step F because the smart contract contains details on how to handle the financial transaction.

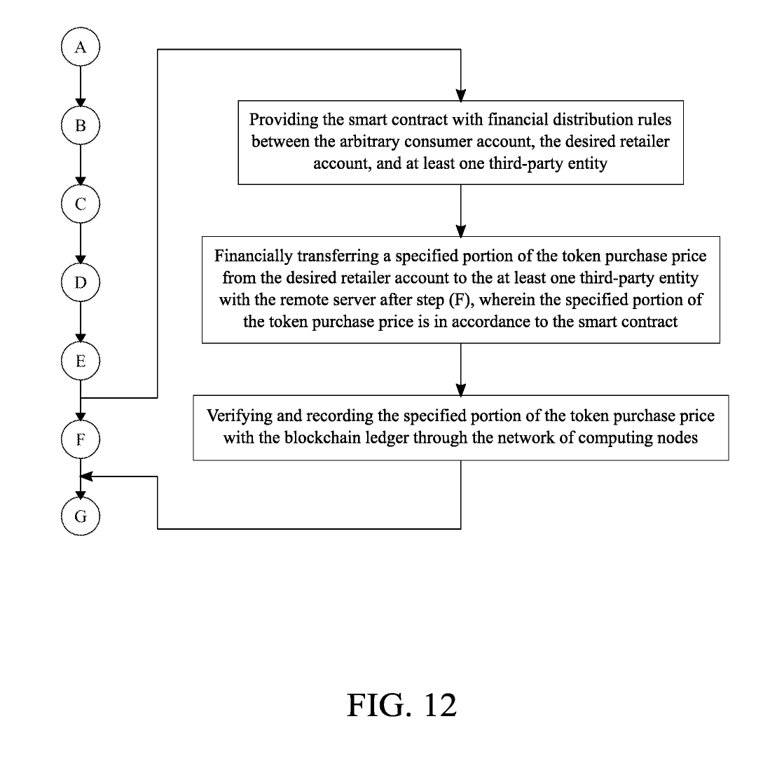

The smart contract is provided with financial distribution rules between the arbitrary consumer account and with reference to FIG. 12, the detailed retailer account, and at least one third-party entity. The financial distribution rules are details of the smart contract referenced on how to handle a financial transaction. In further detail, the financial distribution rules can contain tax distribution information in order to deduct tax from a transaction and deliver the deducted tax to the at least one third-party entity. The at least one third-party entity can be a state government entity and/or a federal government entity depending on the selected good or service. The remote server financially transfers a specified portion of the token purchase price from the desired retailer account to the at least one third-party entity after Step F. The specified portion, as previously mentioned, can be deducted tax from the financial transaction between the arbitrary consumer account and the desired retailer account. The specified portion of the token purchase price is in accordance to the smart contract. The blockchain ledger then verifies and records the specified portion of the token purchase price through the network of computing nodes. This allows the arbitrary consumer account and/or the desired retailer account to decipher the details of a smart contract and the financial transaction.

Although the invention has been explained in relation to its preferred embodiment, it is to be understood that many other possible modifications and variations can be made without departing from the spirit and scope of the invention as hereinafter claimed.

What is claimed is:

1. A method of securely exchanging digital token currency for goods and services, the method comprises the steps of:
(A) providing a plurality of consumer accounts managed by at least one remote server, wherein each consumer account is associated with a corresponding consumer personal computing (PC) device;
(B) providing a plurality of retailer accounts managed by the remoter server, wherein each retailer account is associated with a corresponding retailer PC device;
(C) providing a blockchain ledger managed by a network of computing nodes;
(D) prompting each consumer account to select a good or service from a desired retailer account with the corresponding consumer PC device, wherein the desired retailer account is from the plurality of retailer accounts;
(E) prompting an arbitrary consumer account to confirm a token purchase price of a selected good or service from the desired retailer account with the corresponding consumer PC device, if the arbitrary consumer account selects the good or service in step (D), wherein the arbitrary consumer account is any one from the plurality of consumer accounts;
(F) financially transferring the token purchase price from the arbitrary consumer account to the desired retailer account through the remote server, if the arbitrary consumer account confirms the token purchase price of the selected good or service; and
(G) verifying and recording steps (D) through (F) with the blockchain ledger through the network of computing nodes.

2. The method of securely exchanging digital token currency for goods and services, the method as claimed in claim 1 comprises the steps of:
managing a virtual token wallet for each consumer account with the remote server; and
financially withdrawing the token purchase price from the virtual token wallet of the arbitrary consumer account during step (F).

3. The method of securely exchanging digital token currency for goods and services, the method as claimed in claim 2 comprises the steps of:
(H) retrieving payment information for each consumer account with the corresponding consumer PC device;
(I) prompting the arbitrary consumer account to select a specific number of new virtual tokens with the corresponding consumer PC device;
(J) converting currency from the payment information into the specific number of new virtual tokens with the remote server;
(K) appending the specific number of new virtual tokens into the virtual token wallet of the arbitrary consumer account with the remote server; and
(L) verifying and recording steps (I) through (K) with the blockchain ledger through the network of computing nodes.

4. The method of securely exchanging digital token currency for goods and services, the method as claimed in claim 1 comprises the steps of:
managing a virtual token wallet for each retailer account with the remote server; and
financially depositing the token purchase price into the virtual token wallet of the desired retailer account during step (F).

5. The method of securely exchanging digital token currency for goods and services, the method as claimed in claim 1 comprises the steps of:
(M) providing a contact information for each consumer account;
(N) relaying the contact information of the arbitrary consumer account and the selection of the good or service from the corresponding consumer PC device of the arbitrary consumer account, through the remote server, and to the corresponding retailer PC device of the desired retailer account;
(O) prompting the desired retailer account to input the contact information of the arbitrary consumer account and the token purchase price with the corresponding retailer PC device;
(P) generating a purchase alert with the remote server, wherein the purchase alert includes the token purchase price;
(Q) relaying the purchase alert from the remote server to the contact information of the arbitrary consumer account; and
(R) recording steps (O) through (Q) with the blockchain ledger through the network of computing nodes.

6. The method of securely exchanging digital token currency for goods and services, the method as claimed in claim 1 comprises the steps of:
(S) receiving a purchase alert with the corresponding consumer PC device of the arbitrary consumer account, wherein the purchase alert includes the token purchase price;
(T) prompting the arbitrary consumer account to confirm or decline the purchase alert with the corresponding consumer PC device;
(U) financially transferring the token purchase price from the arbitrary consumer account to the desired retailer account through the remote server, if the arbitrary consumer account confirms the purchase alert;
(V) sending an approval notification to the corresponding retailer PC device of the desired retailer account, if the arbitrary consumer account confirms the purchase alert;
(W) sending a rejection notification to the corresponding retailer PC device of the desired retailer account, if the arbitrary consumer account declines the purchase alert;
(X) recording steps (S) through (W) with the blockchain ledger through the network of computing nodes; and
(Y) verifying step (U) with the blockchain ledger through the network of computing nodes.

7. The method of securely exchanging digital token currency for goods and services, the method as claimed in claim 1 comprises the steps of:
providing a consumer-account creation portal hosted on the remote server;
prompting to input new contact information through the consumer-account creation portal;
generating a verification code with the remote server;
sending the verification code from the remote server to the new contact information;
prompting to enter an attempted code through the consumer-account creation portal; and
appending a new account into the plurality of consumer accounts with the remote server, if the attempted code matches the verification code.

8. The method of securely exchanging digital token currency for goods and services, the method as claimed in claim 1 comprises the steps of:
prompting each consumer account to view the blockchain ledger through the corresponding consumer PC device; and
displaying the blockchain ledger to at least one specific consumer account through the corresponding consumer PC device, if the specific consumer account selects to view the blockchain ledger.

9. The method of securely exchanging digital token currency for goods and services, the method as claimed in claim 1 comprises the steps of:
prompting each retailer account to view the blockchain ledger through the corresponding retailer PC device; and
displaying the blockchain ledger to at least one specific retailer account through the corresponding retailer PC device, if the specific retailer account selects to view the blockchain ledger.

10. The method of securely exchanging digital token currency for goods and services, the method as claimed in claim 1 comprises the steps of:
generating a smart contract between the arbitrary consumer account and the desired retailer account with the remote server;
recording the smart contract with the blockchain ledger through the network of computing nodes; and
referencing the smart contract during step (F).

11. The method of securely exchanging digital token currency for goods and services, the method as claimed in claim 10 comprises the steps of:
providing the smart contract with financial distribution rules between the arbitrary consumer account, the desired retailer account, and at least one third-party entity;
financially transferring a specified portion of the token purchase price from the desire retailer account to the at least one third-party entity with the remote server after step (F), wherein the specified portion of the token purchase price is in accordance to the smart contract; and
verifying and recording the specified portion of the token purchase price with the blockchain ledger through the network of computing nodes.
